(19) United States
(12) Patent Application Publication
(10) Pub. No.: US 2011/0001585 A1
(43) Pub. Date: Jan. 6, 2011

(54) TUNEABLE FILTER AND A METHOD OF TUNING SUCH A FILTER

(76) Inventors: John David Rhodes, Menston (GB); Andrew James Panks, Leeds (GB); Christopher Ian Mobbs, West Yorkshire (GB)

Correspondence Address: HOWARD & HOWARD ATTORNEYS PLLC, 450 West Fourth Street, Royal Oak, MI, 48067, US

(21) Appl. No.: 12/675,878

(22) PCT Filed: Aug. 5, 2008
(86) PCT No.: PCT/GB2008/002652

§ 371 Date: Sep. 9, 2010

(30) Foreign Application Priority Data
Aug. 30, 2007 (GB) 0716843.8

(51) Int. Cl. H01P 1/20

(52) U.S. Cl. 333/209

(57) ABSTRACT

A tuneable filter comprising a filter body defining a tuning cavity; a tuning member within the tuning cavity; and, a linear actuator adapted to displace the tuning member within the cavity to tune the filter; the linear actuator comprising a motor; a drive arm connected to the motor and extending along a drive axis, the drive arm being adapted to be rotated about the drive axis by the motor; an extension arm extending along the drive axis being connected at one end to the tuning member and being in engagement with the drive arm at the other end; the engagement between the drive arm and extension arm being arranged such that rotation of the drive arm about the drive axis displaces the extension arm along the drive axis; each of the drive arm and extension arm comprising an end stop, the end stops being arranged such that as the extension arm reaches the end of its range of travel towards the drive arm the drive arm end stop rotates into abutment with the extension arm end stop, preventing further rotation of the drive arm.

The present invention relates to a tuneable filter and also to a method of tuning such a filter. More particularly, but not exclusively, the present invention relates to a tuneable filter comprising drive arm and an extension arm, the arms being interconnected such that rotation of the drive arm about a drive axis causes linear motion of the extension arm along the drive axis, each arm comprising an end stop, the end stops being arranged to rotationally abut when the extension arm reaches the end of its range of travel preventing further rotation of the drive arm. More particularly, but not exclusively, the present invention relates to a method of tuning such a filter.

Filters for operation at microwave frequencies are known. Such filters comprise a metal filter body defining a tuning cavity, the cavity having input and output ports. The cavity typically comprises a ground face, a capacitive face and at least one side wall therebetween. Within the tuning cavity extending from the ground face part way to the capacitive face is a central metal tuning arm. The resonant frequency of the cavity depends upon the distance between the capacitive face and the end of the tuning arm.

In order to vary the resonant frequency of such a filter one introduces a tuning member between the end of the tuning arm and the capacitive face. By moving the tuning member towards or away from the capacitive face one can alter the resonant frequency of the filter.

For modern wireless applications one must be able to set the frequency of the tuneable filter to an accuracy of around 50 kHz at a frequency of around 2.5 GHz. This translates to an accuracy in positioning of the tuneable member of around 1.5 μm.

In order to position the tuning member with such a high degree of accuracy complex optical or electronic feedback systems are typically used. Mechanical systems used to date have been unable to reliably achieve the required degree of accuracy. Such feedback systems are however relatively complex.

The tuneable filter according to the invention seeks to overcome these problems.

Accordingly, in a first aspect, the present invention provides a tuneable filter comprising
a filter body defining a tuning cavity;
a tuning member within the tuning cavity; and,
a linear actuator adapted to displace the tuning member within the cavity to tune the filter;
the linear actuator comprising
a motor;
a drive arm connected to the motor and extending along a drive axis, the drive arm being adapted to be rotated about the drive axis by the motor;
an extension arm extending along the drive axis being connected at one end to the tuning member and being in engagement with the drive arm at the other end;
the engagement between the drive arm and extension arm being arranged such that rotation of the drive arm about the drive axis displaces the extension arm along the drive axis;
each of the drive arm and extension arm comprising an end stop, the end stops being arranged such that as the extension arm reaches the end of its range of travel towards the drive arm end stop rotates into abutment with the extension arm end stop, preventing further rotation of the drive arm.

The tuneable filter according to the invention comprises relatively simple mechanical components. Nonetheless, the linear actuator of the invention can be employed to reliably position the tuning member with the required degree of accuracy.

Preferably, the tuneable filter further comprises a fixing means adapted to prevent rotation of the extension arm about the drive axis but to allow displacement of the extension arm along the drive axis.

Preferably, at least a portion of the extension arm comprises a tube having a threaded inner surface, the inner surface of the tube being in threaded engagement with the drive arm.

Preferably, the extension arm end stop extends from the inner surface of the tube.

The tube can comprise a blank end remote from the drive arm.

The extension arm end stop can extend from the blank end towards the drive arm.

The extension arm can further comprise an extension arm rod extending between the tube and the tuning member.

The extension arm rod can be in threaded engagement with the tube.

The extension arm end stop can extend from the end of the rod towards the drive arm.

The drive arm end stop can extend from the end of the drive arm.

The drive arm end stop can extend from a side of the drive arm.

The extension arm end stop can extend from the face of the tube which receives the drive arm.

The drive arm can comprise a tube portion having a threaded inner surface, the inner surface being in threaded engagement with the extension arm.

The motor can be a stepper motor.

Alternatively, at least one of the extension arm and drive arm comprises a camming surface and the other arm comprises a protrusion received by the camming surface.

The camming surface can be a spiral.

The pitch of the camming surface can vary along the length of the arm.

The tuneable filter can further comprise a biasing spring adapted to apply a biasing force to the extension arm along the drive axis.

In a further aspect of the invention there is provided a method of tuning a tuneable filter comprising the steps of
providing a tuneable filter as claimed in any one of claims 1 to 18; and,
rotating the drive arm to draw the extension arm towards the motor until the end stops rotate into engagement preventing further rotation.

Preferably, the method further comprises the step of rotating the drive arm a predetermined distance in the opposite direction after the abutment of the end stops.

Preferably, the motor stalls on abutment of the end stops.

The present invention will now be described by way of example only and not in any imitative sense with reference to the accompanying drawings in which

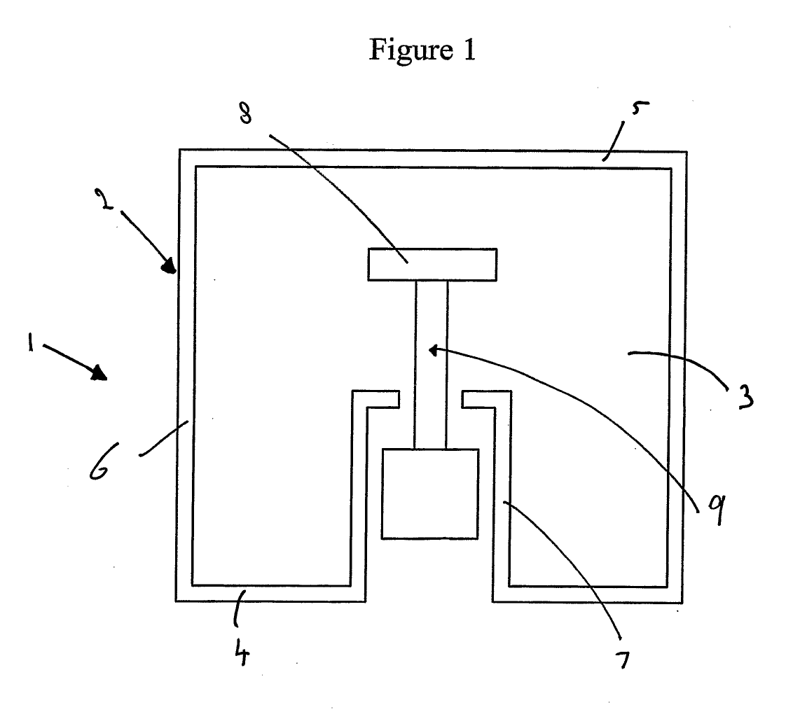

FIG. 1 shows a known tuneable filter in cross section;

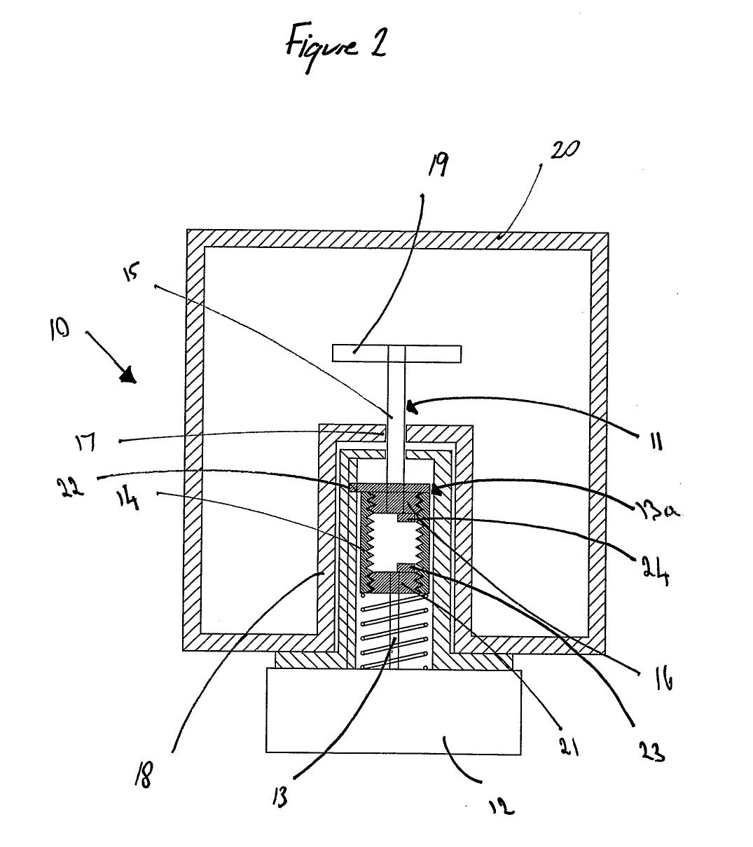

FIG. 2 shows an embodiment of a tuneable filter according to the invention in cross section;

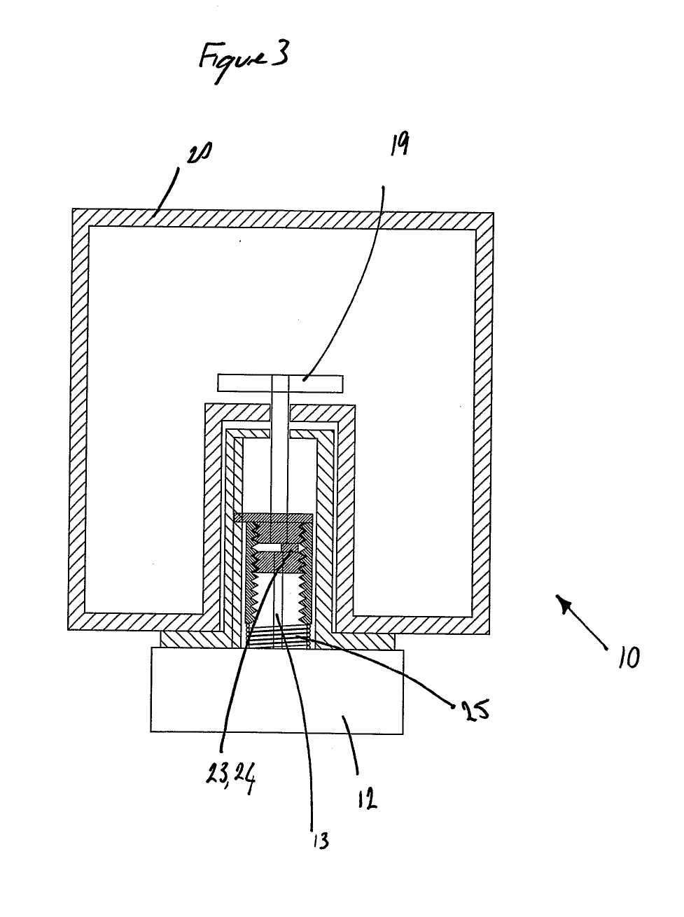

FIG. 3 shows the embodiment of FIG. 2 with the end stops in abutment;

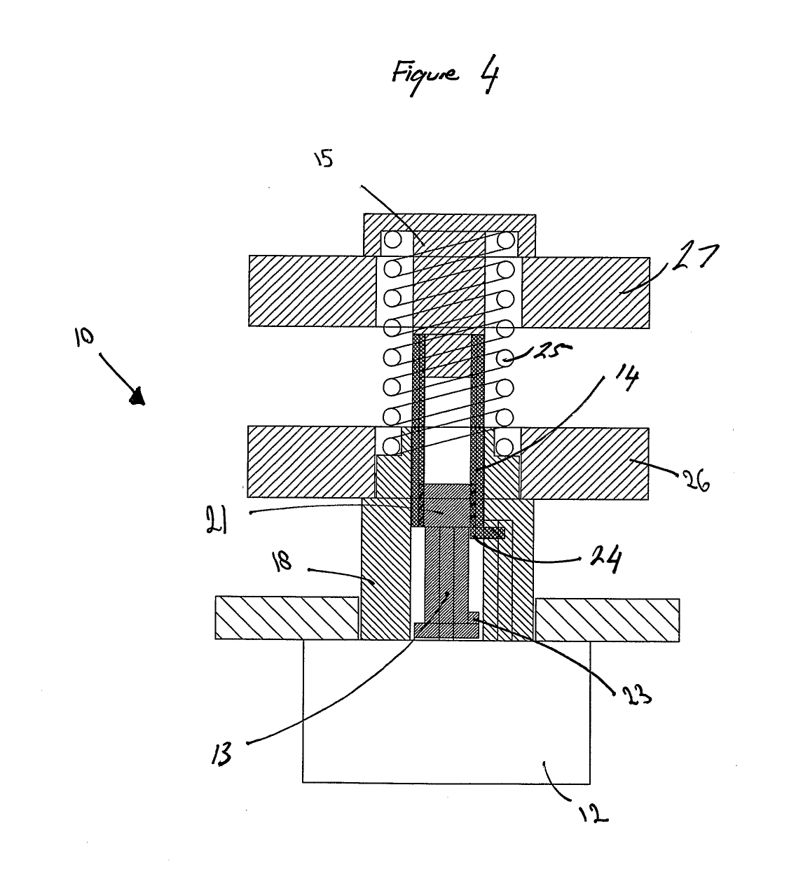

FIG. 4 shows a further embodiment of a tuneable filter according to the invention in cross sectional view; and,

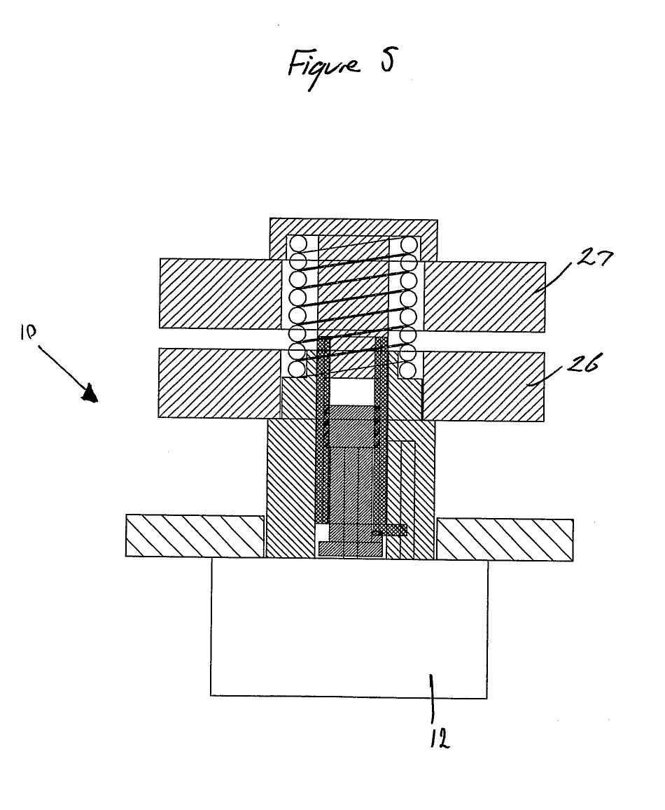

FIG. 5 shows the embodiment of FIG. 4 with the end stops in abutment.

Shown in FIG. 1 is a known tuneable filter 1 in cross sectional view. The filter 1 comprises a filter body 2 defining a tuning cavity 3. The filter body 2 comprises a ground face 4, a capacitive face 5 and side walls 6 extending therebetween. Arranged within the tuning cavity 3 is a tuning arm 7 extending from the ground face 4 part way to the capacitive face 5.

A tuning member 8 is arranged in the gap between the tuning arm 7 and the capacitive face 5. A linear actuator 9 moves the tuning member 8 between an extended position with the tuning member 8 proximate to the capacitive face 5 and a retracted position with the tuning member 8 remote from the capacitive face 5. The resonant frequency of the filter 1 is a function of the distance between the tuning member 8 and capacitive face 5.

Shown in FIG. 2 is a tuneable filter 10 according to the invention. The linear actuator 11 comprises a stepper motor 12. Extending from the stepper motor 12 along a drive axis is a drive arm 13. By applying power to the stepper motor 12 the drive arm 13 can be rotated about the drive axis in small steps. The operation of stepper motors 12 is known and will not be discussed in detail.

The linear actuator 11 further comprises an extension arm 13a. The extension arm 13a is divided into a tube portion 14 and an extension arm rod 15. The inner face of the tube portion 14 is threaded. An end 16 of the extension arm rod 15 is also threaded and is tightly threaded into engagement with the tube portion 14 such that it is not free to rotate with respect to the long axis of the tube portion 14. The end 16 of the extension arm rod 15 has a larger diameter than the remainder of the rod 15 as shown. The opposite end of the extension arm rod 15 extends through an aperture 17 in the end of the tuning arm 18 and is connected to the tuning member 19. Displacement of the extension arm rod 15 along its length displaces the tuning member 19 between the end of the tuning arm 18 and the capacitive face 20.

The end 21 of the drive arm 13 is also threaded. The end 21 of the drive arm 13 is threaded into the opposite end of the tube portion 14 to the extension arm rod 15 such that the drive arm 13 and extension arm 13a extend along the drive axis. As with the extension arm rod 15, the threaded portion 21 of the drive arm 13 has a larger diameter than the remainder of the drive arm 13. A fixing means 22 prevents the extension arm 13a from rotating about the drive axis but allows it to be displaced along the drive axis. In this embodiment the fixing means 22 comprises a protrusion 22 extending from the extension arm rod 15 which is received within a groove (not shown) which extends along the inner face of the tuning arm 18.

In use a signal is sent to the stepper motor 12 which rotates the drive arm 13 about the drive axis. As the extension arm 13a is not free to rotate about the drive axis the rotation of the drive arm 13 relative to the extension arm 13a causes the extension arm 13a to be displaced along the drive axis, so displacing the tuning member 19. If the drive arm 13 is rotated in a first direction the extension arm 13a moves towards its extended position moving the tuning member 19 towards the capacitive face 20. If the drive arm 13 is rotated in the opposite direction the extension arm 13a moves towards its retracted position, moving the tuning member 19 away from the capacitive face 20.

An end stop 23 extends from the end of the drive arm 13 parallel to the drive axis. In this embodiment the end stop 23 comprises a raised segment slightly separated from the drive axis as shown. A similar end stop 24 extends from the end of the extension arm rod 15 towards the drive arm 13.

As the drive arm 13 rotates and the extension arm 13a is drawn towards its retracted position the two end stops 23,24 rotate into abutment preventing further rotation of the drive arm 13. This is shown in more detail in FIG. 3. In this embodiment the motor 12 is arranged such that it stalls when the end stops 23,24 rotationally abut.

The stepper motor 12 has a maximum rotational speed defined by the inductance of the motor windings. In order to ensure that the motor 12 stalls when the end stops 23,24 abut the speed of the motor 12 is arranged to be larger than one third of this maximum speed at abutment. If the motor speed is less than this the motor 12 will rebound when the end stops 23,24 abut and rotate in the opposite direction.

From the retracted position the stepper motor 12 is rotated a predetermined number of steps in the opposite direction. This moves the tuning member 19 towards the capacitive face 20 by a predetermined and accurately known amount. As the starting point of the tuning member 19 is known with a high degree of accuracy this enables the position of the tuning member 19 to be set with a high degree of accuracy. To move the tuning member 19 to a new position one again rotates the drive arm 13 until the extension arm 13a reaches its retracted position with the end stops 23,24 abutting. The drive arm 13 is then rotated in the opposite direction a predetermined number of steps until the new tuning member position is reached.

The tuneable filter 10 according to the invention does not require a complex feedback mechanism to accurately position the tuning member 19. Positioning of the tuning member 19 can be accurately and repeatedly achieved simply by rotating the drive arm 13 until the end stops 23,24 abut and then rotating the drive arm 13 the required number of steps in the opposite direction.

This improvement in reliability and accuracy is achieved because of the way the end stops 23,24 abut. It is important that the end stops 23,24 are arranged such that they rotate into abutment as shown in FIG. 3. What does not happen is that the linear motion of the extension arm 13a along the drive axis causes the extension arm 13a to linearly abut the drive arm 13 with forces along the drive axis preventing further movement of the extension arm 13a. The rotational abutment of the end stops 23,24 prevents further movement of the drive arm 13 before this linear abutment occurs. Linear abutment, rather than rotational abutment in this way causes the thread of the drive arm 13 and/or extension arm rod 15 to tighten in its respective thread in the tube portion 14 of the extension arm 13a. Such tightening can result in a gradual change in the position of the retracted position of the extension arm 13a over time. In addition, such linear abutment can cause the drive arm 13 and extension arm 13a to ‘stick’ together, providing initial resistance to the rotation of the drive arm 13 when the extension arm 13a is in the retracted position, again reducing the accuracy with which the tuning member 19 can be positioned.

The tuneable filter 10 further comprises a biasing spring 25 between the motor 12 and the extension arm 13a. The biasing spring 25 applies a substantially constant biasing force to the extension arm 13a preventing backlash when the drive arm 13 changes direction of rotation.

In an alternative embodiment (not shown) the end stop 24 of the extension arm 13a extends from the inner face of the tube 14 towards the drive axis.

In an alternative embodiment (not shown), the tube 14 of the extension arm 13a ends in a blank and the extension arm rod 15 is connected to the blank. The extension arm rod 15 may be threaded into engagement with a recess in the blank or may be fixed to the blank by other means. The extension arm end stop 24 may extend from the inner face of the blank within the tube 14 or may extend from the inner face of the tube 14.

In a further alternative embodiment, the entire length of the extension arm 13a is a tube 14 with one end of the tube 14 being connected to the tuning member 19 and the other end receiving the threaded drive arm 13.

A further embodiment of the tuneable filter 10 according to the invention is shown in cross section in FIG. 4. In this embodiment the drive arm end stop 23 extends from the side of the drive arm 13 close to the motor 12. The extension arm end stop 24 extends from the end of the extension arm tube 14 which receives the drive arm 13 as shown. Placing the drive arm end stop 23 close to the motor 12 in this way allows a larger range of motion of the extension arm 13a.

In this embodiment a first high Q dielectric tuning member 26 is connected to the end of the tuning arm 18. A second dielectric tuning member 27 is connected to the end of the extension arm 13a remote from the drive arm 13. As the extension arm 13a extends the two tuning members 26,27 separate as shown. The biasing spring 25 extends between the two tuning members 26,27 and so applies a biasing force along the drive axis away from the drive arm 13. In the embodiment of FIGS. 2 and 3 the tuning arm 18 is metallic. The linear actuator within the tuning arm 18 (in particular the biasing spring 25) can therefore be metallic without effecting the Q of the tuning cavity 3. In the embodiment of FIG. 4 the tuning arm 18 is a plastics material. All of the drive arm 13, extension arm 13a and spring 25 must therefore be a plastics material to prevent reduction in Q of the tuning cavity 3.

In a further embodiment of the invention (not shown) the end of the drive arm 13 comprises a tube portion having a threaded inner surface. The inner surface receives an extension arm 13a having a threaded outer surface.

Other alternatives to threaded engagement are possible. In one alternative embodiment the extension arm 13a comprises a camming surface and the drive arm 13 comprises a protrusion to be received by the camming surface. A camming surface may offer a greater degree of control over the movement of the extension arm 13a as a function of rotation of the drive arm 13 than a threaded engagement. The resonant frequency of the filter 10 varies more rapidly with tuning member position as the tuning member 19 approaches the capacitive face 20. In a preferred embodiment the camming surface comprises a spiral on the inside of the tube portion having a pitch which varies with position along the length of the tube portion. The pitch is arranged such that the tuneable filter exhibits a resonant frequency which varies linearly with degree of rotation of the drive arm 13.

In an alternative embodiment the drive arm 13 comprises the camming surface and the extension arm 13a comprises the corresponding protrusion.

Motors 12 other than stepper motors are possible provided the motor 12 can produce a small and reproducible degree of rotation of the drive arm 13 in response to an external signal.

1. A tuneable filter comprising
a filter body defining a tuning cavity;
a tuning member within the tuning cavity; and,
a linear actuator adapted to displace the tuning member within the cavity to tune the filter;
the linear actuator comprising
a motor;
a drive arm connected to the motor and extending along a drive axis, the drive arm being adapted to be rotated about the drive axis by the motor; and
an extension arm extending along the drive axis being connected at one end to the tuning member and being in engagement with the drive aim at the other end;
the engagement between the drive arm and extension arm being arranged such that rotation of the drive arm about the drive axis displaces the extension arm along the drive axis; and
each of the drive arm and extension arm comprising an end stop, the end stops being arranged such that as the extension arm reaches the end of its range of travel towards the drive arm the drive arm end stop rotates into abutment with the extension arm end stop, preventing further rotation of the drive arm.

2. A tuneable filter as claimed in claim 1, further comprising a fixing means adapted to prevent rotation of the extension arm about the drive axis but to allow displacement of the extension arm along the drive axis.

3. A tuneable filter as claimed in claim 1, wherein at least a portion of the extension arm comprises a tube having a threaded inner surface, the inner surface of the tube being in threaded engagement with the drive arm.

4. A tuneable filter as claimed in claim 3, wherein the extension arm end stop extends from the inner surface of the tube.

5. A tuneable filter as claimed in claim 3, or wherein the tube comprises a blank end remote from the drive arm.

6. A tuneable filter as claimed in claim 5, wherein the extension arm end stop extends from the blank end towards the drive arm.

7. A tuneable filter as claimed in claim 3, wherein the extension arm further comprises an extension arm rod extending between the tube and the tuning member.

8. A tuneable filter as claimed in claim 7, wherein the extension arm rod is in threaded engagement with the tube.

9. A tuneable filter as claimed claim 7, wherein the extension arm end stop extends from the end of the rod towards the drive arm.

10. A tuneable filter as claimed in claim 1, wherein the drive aim end stop extends from the end of the drive arm.

11. A tuneable filter as claimed in claim 1, wherein the drive aim end stop extends from a side of the drive arm.

12. A tuneable filter as claimed in claim 11, when dependent on claim 3, wherein the extension arm end stop extends from the face of the tube which receives the drive arm.

13. A tuneable filter as claimed in claim 1, wherein the drive arm comprises a tube portion having a threaded inner surface, the inner surface being in threaded engagement with the extension arm.

14. A tuneable filter as claimed in claim 1, wherein the motor is a stepper motor.

15. A tuneable filter as claimed in claim 1, wherein one of the extension arm and drive arm comprises a camming surface and the other arm comprises a protrusion received by the camming surface.

16. A tuneable filter as claimed in claim 15, wherein the camming surface is a spiral.

17. A tuneable filter as claimed in claim 16, wherein the pitch of the camming surface varies along the length of the arm.

18. A tuneable filter as claimed in claim 1, further comprising a biasing spring adapted to apply a biasing force to the extension arm along the drive axis.

19. A method of tuning a tuneable filter having a filter body defining a tuning cavity, a tuning member within the tuning cavity, a linear actuator adapted to displace the tuning member within the cavity to tune the filter, the linear actuator comprising a motor, a drive arm connected to the motor and extending along a drive axis, the drive arm being adapted to be rotated about the drive axis by the motor, and an extension arm extending along the drive axis being connected at one end to the tuning member and being in engagement with the drive arm at the other end, the engagement between the drive arm and extension arm being arranged such that rotation of the drive arm about the drive axis displaces the extension arm along the drive axis, and each of the drive arm and extension arm comprising an end stop, the end stops being arranged such that as the extension arm reaches the end of its range of travel towards the drive arm the drive arm end stop rotates into abutment with the extension arm end stop, preventing further rotation of the drive arm, said method comprising the step
rotating the drive arm to draw the extension arm towards the motor until the end stops rotate into engagement preventing further rotation.

20. A method as claimed in claim 19, further comprising the step of rotating the drive arm a predetermined distance in the opposite direction after the abutment of the end stops.

21. A method as claimed in claim 19, wherein the motor stalls on abutment of the end stops.

22. (canceled)

23. (canceled)
